(19) United States
(12) Patent Application Publication
(10) Pub. No.: US 2013/0120900 A1
(43) Pub. Date: May 16, 2013

(54) MULTILAYER CERAMIC ELECTRONIC PART AND METHOD OF MANUFACTURING THE SAME

(71) Applicant: SAMSUNG ELECTRO-MECHANICS CO., LTD., Gyunggi-do (KR)

(72) Inventors: Hae Suk CHUNG, Gyunggi-do (KR); Min Cheol PARK, Gyunggi-do (KR); Hyung Joon KIM, Gyunggi-do (KR); Byoung Hwa LEE, Gyunggi-do (KR)

(73) Assignee: SAMSUNG ELECTRO-MECHANICS CO., LTD., Gyunggi-do (KR)

(21) Appl. No.: 13/670,074

(22) Filed: Nov. 6, 2012

(30) Foreign Application Priority Data
Nov. 16, 2011 (KR) 10-2011-0119576

(51) Int. Cl. H01G 4/005; H01G 4/12

(52) U.S. Cl. CPC H01G 4/005; H01G 4/12
USPC 361/303; 156/89.12

(57) ABSTRACT

There is provided a multilayer ceramic electronic part, including: a ceramic element having a plurality of dielectric layers laminated therein; first and second internal electrodes formed on at least one surface of each of the plurality of dielectric layers within the ceramic element and exposed through one surface of the ceramic element; and first and second external electrodes formed on one surface of the ceramic element and electrically connected to the first and second internal electrodes through exposed portions of the respective first and second internal electrodes, wherein a ratio of an area of the first or second external electrode to an area of one surface of the ceramic element is 10 to 40%.

### CROSS-REFERENCE TO RELATED APPLICATIONS

This application claims the priority of Korean Patent Application No. 10-2011-0119576 filed on Nov. 16, 2011, in the Korean Intellectual Property Office, the disclosure of which is incorporated herein by reference.

### BACKGROUND OF THE INVENTION

1. Field of the Invention

The present invention relates to a multilayer ceramic electronic part and a method of manufacturing the same.

2. Description of the Related Art

Electronic parts using a ceramic material include a capacitor, an inductor, a piezoelectric element, a varistor, a thermistor, or the like.

Among these ceramic electronic parts, a multi-layer ceramic capacitor (MLCC) may have advantages such as a small size, high capacity, and easy mounting thereof.

A multilayer ceramic capacitor is a chip type condenser having a main function of being charged with or discharging electricity while being mounted on a circuit board used in a variety of electronic products, such as a computer, a personal digital assistant (PDA), a cellular phone, and the like. The multilayer ceramic capacitor may have various sizes and lamination types, depending on the intended usage and capacity thereof.

In particular, with the recent trend for the miniaturization of electronic products, ultra-miniaturized, ultra-high capacity multi-layer ceramic capacitors have been also been required.

For this reason, a multi-layer ceramic capacitor, in which dielectric layers and internal electrodes are thinly formed for the ultra-miniaturization of products and a large number of dielectric layers are laminated for the ultra-high capacitance thereof, has been manufactured.

Meanwhile, there may be provided multilayer ceramic capacitors having all external electrodes positioned on lower surfaces thereof. Multilayer ceramic capacitors having this type of structure have advantages of superior mounting density and capacitance as well as low ESL, but may be cracked, since adhesive strength may be low and one surface of a laminate may be warped.

### SUMMARY OF THE INVENTION

An aspect of the present invention provides a multilayer ceramic capacitor having bottom electrodes, allowing for increased adhesive strength and reduced warpage-induced cracks.

According to an aspect of the present invention, there is provided a multilayer ceramic electronic part, including: a ceramic element having a plurality of dielectric layers laminated therein; first and second internal electrodes formed on at least one surface of each of the plurality of dielectric layers within the ceramic element and exposed through one surface of the ceramic element; and first and second external electrodes formed on one surface of the ceramic element and electrically connected to the first and second internal electrodes through exposed portions of the respective first and second internal electrodes, wherein a ratio of an area of the first or second external electrode to an area of one surface of the ceramic element is 10 to 40%.

The first and second external electrodes may have equal areas.

The first and second external electrodes may have unequal areas.

A distance between the first external electrode and an end of the ceramic element may be equal to a distance between the second external electrode and an opposite end of the ceramic element.

A distance between the first external electrode and an end of the ceramic element may be different from a distance between the second external electrode and an opposite end of the ceramic element.

The first and second external electrodes may be biased towards one side of the ceramic element in a length direction thereof.

The first and second external electrodes may be left-and-right symmetrical with regard to a middle of the ceramic element.

The first and second external electrodes may be formed such that all margin parts of the ceramic element to have the same width.

According to another aspect of the present invention, there is provided a multilayer ceramic electronic part, including: a ceramic element having a plurality of dielectric layers laminated therein; first and second internal electrodes formed on at least one surface of each of the plurality of dielectric layers within the ceramic element and exposed through one surface of the ceramic element; and first and second external electrodes formed on one surface of the ceramic element and electrically connected to the first and second internal electrodes through exposed portions of the respective first and second internal electrodes, wherein a ratio of a distance between the first or second external electrode and an end of the ceramic element to a length of one surface of the ceramic element is 4 to 18%.

A distance between the first external electrode and an end of the ceramic element may be equal to a distance between the second external electrode and an opposite end of the ceramic element.

A distance between the first external electrode and an end of the ceramic element may be different from a distance between the second external electrode and an opposite end of the ceramic element.

The first and second external electrodes may be biased towards one side of the ceramic element in a length direction thereof.

The first and second external electrodes may be left-and-right symmetrical with regard to a middle of the ceramic element.

The first and second external electrodes may be formed such that all margin parts of the ceramic element to have the same width.

According to another aspect of the present invention, there is provided a method of manufacturing a multilayer ceramic electronic part, including: forming first and second internal electrode layers on at least one surface of each of first and second ceramic sheets; alternately laminating the first and second ceramic sheets having the respective first and second internal electrode layers formed thereon, to form a laminate; sintering the laminate; and forming first and second external electrodes on one surface of the laminate so as to be electrically connected to the respective first and second internal electrode layers, wherein a ratio of an area of the first or second external electrode to an area of one surface of the laminate is 10 to 40%.

The first external electrode and the second external electrode may have equal areas.

The first external electrode and the second external electrode may have unequal areas.

A distance between the first external electrode and an end of the laminate may be equal to a distance between the second external electrode and an opposite end of the laminate.

A distance between the first external electrode and an end of the laminate may be different from a distance between the second external electrode and an opposite end of the laminate.

The first and second external electrodes may be biased towards one side of the laminate in a length direction thereof.

The first and second external electrodes may be left-and-right symmetrical with regard to a middle of the laminate.

The first and second external electrodes may be formed such that all margin parts of the laminate have the same width.

According to another aspect of the present invention, there is provided a method of manufacturing a multilayer ceramic electronic part, including: forming first and second internal electrode layers on at least one surface of each of first and second ceramic sheets; alternately laminating the first and second ceramic sheets having the respective first and second internal electrode layers formed thereon, to form a laminate; sintering the laminate; and forming first and second external electrodes on one surface of the laminate so as to be electrically connected to the respective first and second internal electrode layers, wherein a ratio of a distance between the first or second external electrode and an end of the laminate to a length of one surface of the laminate is 4 to 18%.

The first external electrode and the second external electrode may have equal areas.

The first external electrode and the second external electrode may have unequal areas.

A distance between the first external electrode and an end of the laminate may be equal to a distance between the second external electrode and an opposite end of the laminate.

A distance between the first external electrode and an end of the laminate may be different from a distance between the second external electrode and an opposite end of the laminate.

The first and second external electrodes may be biased towards one side of the laminate in a length direction thereof.

The first and second external electrodes may be left-and-right symmetrical with regard to a middle of the laminate.

The first and second external electrodes may be formed such that all margin parts of the laminate have the same width.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a schematic structure of a multilayer ceramic capacitor according to an embodiment of the present invention;

FIG. 2 is an exploded perspective view of FIG. 1;

FIG. 3 is a cross sectional view showing a coupling structure of a first internal electrode and a first external electrode of FIG. 1;

FIG. 4 is a cross sectional view showing a coupling structure of a second internal electrode and a second external electrode of FIG. 1;

FIG. 5 is a cross sectional view showing a coupling structure of the first and second internal electrodes and the first and second external electrodes of FIG. 1; and

FIG. 6 is a front view of FIG. 1.

### DETAILED DESCRIPTION OF THE PREFERRED EMBODIMENT

Hereinafter, embodiments of the present invention will be described in detail with reference to the accompanying drawings.

However, the invention may be embodied in many different forms and should not be construed as being limited to the embodiments set forth herein.

The embodiments of the present invention are provided so that those skilled in the art may more completely understand the present invention.

In the drawings, the shapes and dimensions may be exaggerated for clarity, and the same reference numerals will be used throughout to designate the same or like components.

In addition, like reference numerals denote parts performing similar functions and actions throughout the drawings.

In addition, unless explicitly described otherwise, “comprising” any components will be understood to imply the inclusion of other components but not the exclusion of any other components.

The present invention is directed to a ceramic electronic part, and the ceramic electronic part according to an embodiment of the present invention is a multilayer ceramic capacitor, an inductor, a piezoelectric element, a varistor, a chip resistor, a thermistor, or the like. The multilayer ceramic capacitor will be described as one example of the ceramic electronic part as follows.

In addition, in the embodiment, for the convenience of explanation, a forward direction is defined by a direction in which external electrodes are formed within a ceramic element, and a lateral direction is defined by a length direction of internal electrodes.

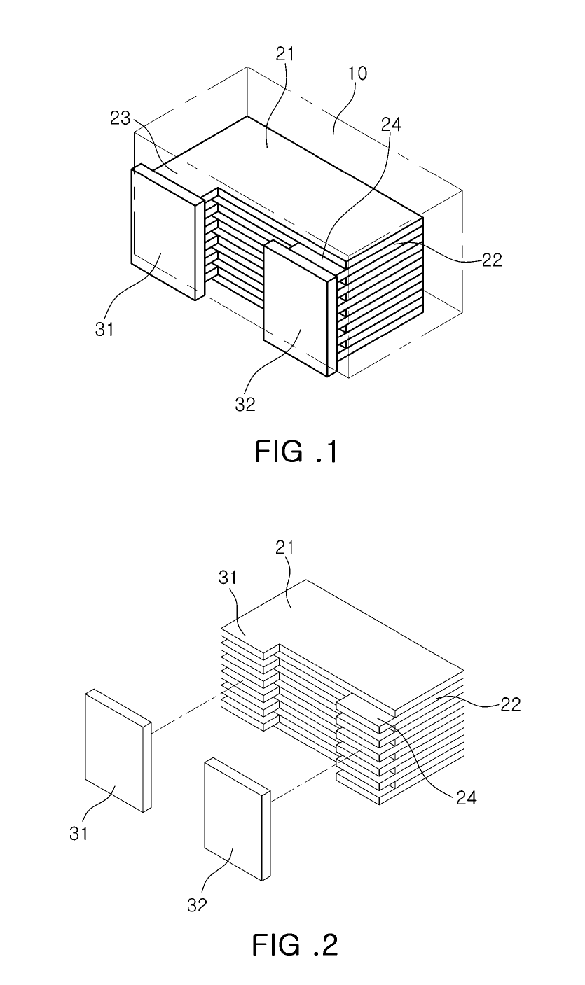

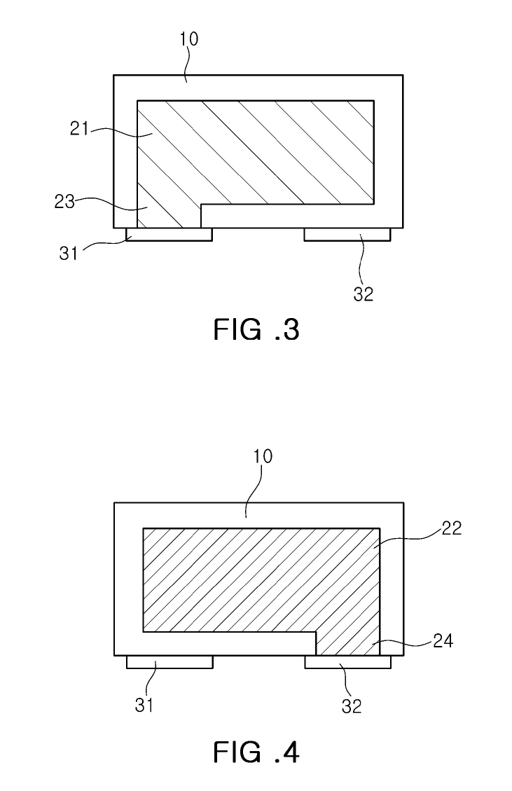

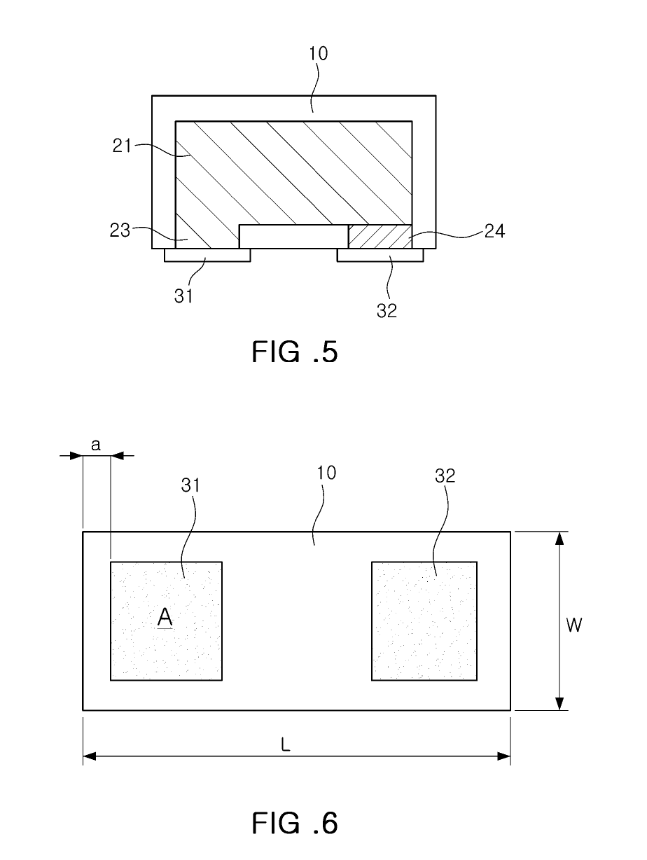

Referring to FIGS. 1 through 6, a multilayer ceramic capacitor 1 according to the present embodiment may include a ceramic element 10 having a plurality of dielectric layers laminated therein; first and second internal electrodes 21 and 22 formed on at least one surface of each of the plurality of dielectric layers within the ceramic element and exposed through one surface of the ceramic element 10; and first and second external electrodes 31 and 32 formed on one surface of the ceramic element 10 and electrically connected to the respective first and second internal electrodes 21 and 22 through exposed portions of the first and second internal electrodes 21 and 22.

Here, a ratio of an area of the first or second external electrode 31 or 32 to an area of one surface of the ceramic element 10 in the forward direction, on which the first and second external electrodes 31 and 32 are formed, may be set to 10 to 40%.

These numerical values will be described in more detail by comparing Inventive Examples and Comparative examples, as follows.

The multilayer ceramic capacitor according to the embodiment may be a 2-terminal vertically laminated or vertical multilayer capacitor.

The “2-terminal” means that two terminals of the capacitor are connected to a circuit board. The “vertically laminated or vertical multilayer” means that internal electrodes laminated within the capacitor are disposed vertically to a mounting surface of the circuit board.

In accordance with this structure, the first and second internal electrodes 21 and 22 may have first and second lead parts 23 and 24 extended from the first and second internal electrodes to be exposed through one surface of the ceramic element 10 in the forward direction, respectively.

In other words, the first and second external electrodes 31 and 32 formed on the surface of the ceramic element 10 in the forward direction may be connected to exposed portions of the first and second lead parts 23 and 24, and thereby electrically connected to the first and second internal electrodes 21 and 22, respectively.

The ceramic element 10 may be formed by laminating the plurality of dielectric layers.

Here, the plurality of dielectric layers constituting the ceramic element 10 may be sintered and integrated such that a boundary between adjacent dielectric layers may not be readily apparant.

Also, the ceramic element 10 is not particularly limited in view of a shape thereof, but may generally have a rectangular parallelepiped shape.

In addition, the size of the ceramic element 10 is not particularly limited, but for example, the ceramic element 10 may be formed to have a size of 0.6 mm×0.3 mm or the like, and thus, this ceramic element 10 may constitute a multilayer ceramic capacitor having high capacitance of 1.0 μF or higher.

In addition, a cover dielectric layer (not shown) having a predetermined thickness may be formed on the outermost surface of the ceramic element 10, that is, on upper and lower surfaces of the ceramic element 10, in the drawings.

The dielectric layers constituting this ceramic element 10 may contain ceramic powder, for example, a BaTiO₃-based ceramic powder or the like.

The BaTiO₃-based ceramic powder may be (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like, in which, for example, Ca, Zr, or the like is employed in BaTiO₃, but is not particularly limited thereto.

The ceramic powder may have an average particle size of 0.81 μm or less, and more preferably 0.05 to 0.51 μm, but is not particularly thereto.

As necessary, the dielectric layers may further contain at least one of transition metal oxides or carbides, rare earth elements, Mg, and Al, together with the ceramic powder.

In addition, a thickness of each dielectric layer may be arbitrarily changed depending on a capacity design of the multilayer ceramic capacitor 1.

In the present embodiment, each dielectric layer may have a thickness of 1.0 μm, preferably, 0.01 to 1.0 μm, but the present invention is not limited thereto.

The first and second electrodes 21 and 22 may be formed of a conductive paste containing a conductive metal.

Here, the conductive metal may be nickel (Ni), copper (Cu), palladium (Pd) or an alloy thereof, and the present invention is not limited thereto.

The internal electrodes 21 and 22 are printed on the ceramic green sheets constituting the dielectric layers by using the conductive paste through a printing method, such as screen printing or gravure printing. Then, the ceramic green sheets on which the internal electrode layers are printed are alternately laminated and subjected to sintering, thereby forming the ceramic element 10.

Therefore, capacitance is formed in an overlapping region in which the first and second internal electrodes 21 and 22 overlap with each other.

In addition, thicknesses of the first and second inner electrode layers 21 and 22 may be determined depending on an intended use thereof or the like, and for example, may be determined within a range of 0.2 to 1.0 μm in consideration of the size of the ceramic element 10. However, the present invention is not limited thereto.

When the first and second internal electrodes 21 and 22 are formed on the dielectric layers, predetermined margin parts are disposed between the dielectric layers and the respective first and second internal electrodes 21 and 22, in order to prevent moisture or a plating liquid from permeating into the internal electrodes and prevent an electric short circuit.

Therefore, the respective first and second lead parts 23 and 24 may be formed on the margin parts of the dielectric layers such that they are extended from one surfaces of the respective first and second internal electrodes 21 and 22, in order to electrically connect the first and second internal electrodes 21 and 22 to the respective first and second external electrodes 31 and 32 formed on the surfaces of the dielectric layers in the forward direction and having different polarities.

Respective ends of the first and second lead parts 23 and 24 may be exposed through one surface of the ceramic element 10 in the forward direction.

Here, each of the first and second lead parts 23 and 24 should not overlap with each other so as to be connected to only each of the first and second external electrodes 31 and 32 having different polarities.

Therefore, the first and second lead parts 23 and 24 may be disposed alternately with each other in the lateral direction along a length of the first and second internal electrodes.

Here, widths of the first and second lead parts 23 and 24 may be the same as each other, but the present invention is not limited thereto. As necessary, lengths of the first and second lead parts 23 and 24 may be different from each other.

In addition, it may be determined that thicknesses of the first and second lead parts 23 and 24 are the same as those of the first and second internal electrodes 21 and 22.

For example, in the embodiment, since the first and second internal electrodes 21 and 22 each have a thickness of 0.2 to 1.0 μm, the thickness of each of the first and second lead parts 23 and 24 may be determined to be 0.2 to 1.0 μm, but the present invention is not limited thereto.

In the embodiment, the first and second external electrodes 31 and 32 may be formed only on one surface of the ceramic element 10 in the forward direction.

Therefore, since a total mounting area of the first and second external electrodes 31 and 32 is relatively reduced as compared with other structures in which left and right external electrodes are formed, mounting density of the circuit board may be improved.

Here, more preferably, the first and second internal electrodes 21 and 22 may be laminated in a direction perpendicular to a direction in which the first and second external electrodes 31 and 32 are formed, in order to increase the mounting density of the circuit board.

As described above, the ratio of an area of the first or second external electrode 31 or 32 to an area of one surface of the ceramic element 10 in the forward direction, on which the first and second external electrodes 31 and 32 are formed, may be set to 10 to 40%.

Here, the first and second external electrodes 31 and 32 may have equal areas, but the present invention is not limited thereto. The first and second external electrodes 31 and 32 may be formed to have unequal areas within the above numerical range.

In addition, in order to increase adhesive strength and prevent warpage cracks, a ratio of a distance (a) between the first or second external electrode 31 or 32 and an end of the ceramic element 10 to a length (L) of one surface of the ceramic element 10 may be controlled to be 4 to 18%.

Here, the distance between the first external electrode 31 and the end of the ceramic element 10 may be formed to be equal to the distance between the second external electrode 32 and the opposite end of the ceramic element 10, but the present invention is not limited thereto. The distances may be different within the above numerical range.

In other words, the first and second external electrodes 31 and 32 may be disposed to be left-and-right symmetrical with regard to the middle of the ceramic element 10, or may be biased towards one side of the ceramic element 10 in a length direction thereof, as necessary.

Also, on one surface of the ceramic element 10 in the forward direction, margin parts between the first and the second external electrodes 31 and 32 and edges of the ceramic element 10 may have the same width, if necessary.

Meanwhile, the first and second external electrodes 31 and 32 may be formed to have a height corresponding to that of the ceramic element 10 so that they are stably connected to the plurality of first and second internal electrodes 21 and 22 laminated in a vertical direction.

However, the present invention is not limited thereto, and, as necessary, the first and second external electrodes 31 and 32 may be formed to have a height greater than or lower than that of the ceramic element 10.

The respective first and second lead parts 23 and 24 are formed in the middle of the respective first and second external electrodes 31 and 32 in the lateral direction, to thereby prevent the permeation of a plating liquid.

The present applicant confirmed a ratio range within which a ratio of an area of the first or second external electrode 31 or 32 to an area of one surface of the ceramic element 10 may be controlled, such that adhesive strength may be increased and warpage cracks may be prevented.

If the ratio of an area of the first or second external electrode 31 or 32 to an area of one surface of the ceramic element 10 is below 10%, the adhesive strength may be degraded. If the ratio of an area of the first or second external electrode 31 or 32 to an area of one surface of the ceramic element 10 is above 40%, a margin part of one surface of the ceramic element 10, on which the first and second external electrodes 31 and 32 are formed, become extremely small, and thus, delamination may occur, resulting in warpage cracks.

Therefore, the ratio of an area of the first or second external electrode 31 or 32 to an area of one surface of the ceramic element 10 may be preferably set to 10 to 40%.

Hereinafter, the present invention will be described in detail by exemplifying Inventive Examples and Comparative Examples therefor.

As described above, when the area of the first or second external electrode 31 or 32 was A, the length and a width of one surface of the ceramic element 10 were L and W, respectively, and the distance between the end of the ceramic element 10 and the first or second external electrode 31 or 32 was a, properties of multilayer ceramic capacitors were measured as shown in Tables 1 through 3 below.

A plurality of chips were manufactured by printing the first and second internal electrodes 21 and 22 having first and second lead parts 23 and 24 and the first and second external electrodes 31 and 32 on molded sheets having a thickness of 2 μm, according to sizes thereof.

As shown in Table 1, the length (L) and the width (W) of one surface of the ceramic element 10 were set to be 0.4 mm and 0.2 mm, respectively, and the area (A) of the first or second external electrode 31 or 32 was variously changed.

Then, among the plurality of chips, the number of chips in which the first or second lead part 23 or 24 was electrically disconnected from the first or second external electrode 31 or 32, or delamination occurred, and adhesive strength values of the chips were checked.

TABLE 1

| | | | | | | | | # of | # of | Adhesive |
|---|---|---|---|---|---|---|---|---|---|---|
| | [symbol] | [symbol] | [symbol] | [symbol] | [symbol] | [symbol] | A/L × W | diconnectivity | [symbol] | strength (N) |
| 1 | 0.007 | [symbol] | 0.08 | 0.4 | 0.2 | 19.4% | 8.8% | 21 | 0 | 0.65 |
| 2 | 0.0075 | 0.076 | 0.08 | 0.4 | 0.2 | 18.9% | 9.4% | 12 | 0 | 0.8 |
| 3 | 0.009 | [symbol] | 0.08 | 0.4 | 0.2 | 17.5% | 11.3% | 0 | 0 | 1.2 |
| 4 | 0.017 | 0.046 | 0.08 | 0.4 | 0.2 | 11.6% | 21.3% | 0 | 0 | [symbol] |
| 5 | 0.019 | [symbol] | 0.08 | 0.4 | 0.2 | 10.4% | 23.8% | 0 | 0 | 1.5 |
| 6 | 0.02 | [symbol] | 0.08 | 0.4 | 0.2 | 9.8% | 25.0% | 0 | 0 | 1.6 |
| 7 | [symbol] | 0.017 | 0.08 | 0.4 | 0.2 | 4.2% | 38.1% | 0 | 0 | 1.7 |
| 8 | 0.0328 | 0.013 | 0.08 | 0.4 | 0.2 | 3.1% | 41.0% | 0 | [symbol] | 1.8 |
| 9 | [symbol] | 0.009 | 0.08 | 0.4 | 0.2 | 2.2% | 43.8% | 0 | [symbol] | 2 |

[symbol]

indicates data missing or illegible when filed

### <Properties of Multilayer Ceramic Capacitors According to the Specification of Ceramic Element and External Electrode>

Referring to Table 1, in Samples 1 and 2, which were Comparative Examples, a ratio of an area of the first or second external electrode 31 or 32 to an area of one surface of the ceramic element 10 was below 10%. In these cases, many defective products having disconnectivity between the first or second external electrode 31 or 32 and the lead part 23 or 24 due to low adhesive strength were found, and thus, it could be seen that there were defects in reliability thereof.

In addition, in Samples 8 and 9, which were Comparative Examples, the ratio of an area of the first or second external electrode 31 or 32 to an area of one surface of the ceramic element 10 was above 40%. In these cases, there were no defects in relation to connection between the first or second external electrode 31 or 32 and the lead part 23 or 24, but many defective products having delamination due to a reduction in the area of the margin part of the ceramic element 10 were found, and thus, it could be seen that there were defects in reliability thereof.

TABLE 2

| | | | | | | | | # of | # of | Adhesive |
|---|---|---|---|---|---|---|---|---|---|---|
| | [symbol] | [symbol] | [symbol] | [symbol] | [symbol] | [symbol] | A/L × W | diconnectivity | [symbol] | strength (N) |
| 1 | 0.015 | 0.118 | 0.18 | 0.6 | 0.3 | 19.7% | 8.3% | 25 | 0 | 1.5 |
| 2 | 0.017 | [symbol] | 0.18 | 0.6 | 0.3 | 18.8% | 9.4% | 16 | 0 | [symbol] |
| 3 | 0.02 | [symbol] | 0.18 | 0.6 | 0.3 | 17.6% | 11.1% | 0 | 0 | 2.2 |
| 4 | 0.03 | [symbol] | 0.18 | 0.6 | 0.3 | [symbol] | 16.7% | 0 | 0 | 2.4 |
| 5 | 0.04 | 0.067 | 0.18 | 0.6 | 0.3 | [symbol] | 22.2% | 0 | 0 | 2.6 |
| 6 | 0.068 | 0.026 | 0.18 | 0.6 | 0.3 | 4.4% | 37.8% | 0 | 0 | 2.8 |
| 7 | 0.074 | 0.019 | 0.18 | 0.6 | 0.3 | [symbol] | [symbol] | 0 | 3 | 3.1 |
| 8 | 0.08 | 0.011 | 0.18 | 0.6 | 0.3 | 1.9% | 44.4% | 0 | 17 | 3.4 |

[symbol]

indicates data missing or illegible when filed

### <Properties of Multilayer Ceramic Capacitors According to the Specification of Ceramic Element and External Electrode>

As shown in Table 2, the length (L) and the width (W) of one surface of the ceramic element 10 were set to 0.6 mm and 0.3 mm respectively, and the area (A) of the first or second external electrode 31 or 32 was variously changed. Then, among the plurality of chips, the number of chips in which the first or second lead part 23 or 24 was electrically disconnected from the first or second external electrode 31 or 32, or delamination occurred was checked, and adhesive strength values of the chips were checked.

Referring to Table 2, in Samples 1 and 2, which were comparative examples, the ratio of an area of the first or second external electrode 31 or 32 to an area of one surface of the ceramic element 10 was below 10%. In these cases, many defective products having disconnection between the first or second external electrode 31 or 32 and the lead part 23 or 24 due to low adhesive strength were found, and thus, it could be seen that there were defects in reliability thereof.

In addition, in Samples 7 and 8, which were Comparative Examples, the ratio of an area of the first or second external electrode 31 or 32 to an area of one surface of the ceramic element 10 was above 40%. In these cases, there were no defects in relation to connection between the external electrode and the lead part, but many defective products having delamination due to a reduction in an area of the margin part of the ceramic element 10 were found, and thus, it could be seen that there were defects in reliability thereof.

TABLE 3

| | | | | | | | | # of | # of | Adhesive |
|---|---|---|---|---|---|---|---|---|---|---|
| | [symbol] | [symbol] | [symbol] | [symbol] | [symbol] | a/L | A/L × W | diconnectivity | [symbol] | Strength (N) |
| 1 | 0.017 | 0.185 | 0.5 | 1.0 | 0.5 | 18.5% | 3.4% | 29 | 0 | 3.8 |
| 2 | 0.019 | 0.181 | 0.5 | 1.0 | 0.5 | 18.1% | 3.8% | 11 | 0 | 4.1 |
| 3 | 0.052 | [symbol] | 0.5 | 1.0 | 0.5 | 13.6% | 10.4% | 0 | 0 | 5.5 |
| 4 | [symbol] | 0.118 | 0.5 | 1.0 | 0.5 | 11.8% | 14.0% | 0 | 0 | 5.7 |
| 5 | [symbol] | 0.096 | 0.5 | 1.0 | 0.5 | 9.6% | 19.0% | 0 | 0 | 6 |
| 6 | 0.11 | 0.084 | 0.5 | 1.0 | 0.5 | 8.4% | 22.0% | 0 | 0 | 6.3 |
| 7 | [symbol] | 0.056 | 0.5 | 1.0 | 0.5 | 5.6% | 30.0% | 0 | 0 | 7 |
| 8 | 0.175 | 0.041 | 0.5 | 1.0 | 0.5 | 4.1% | 35.0% | 0 | 0 | 8 |
| 9 | [symbol] | 0.024 | 0.5 | 1.0 | 0.5 | 2.4% | 41.0% | 0 | 3 | 12 |
| 10 | 0.21 | 0.021 | 0.5 | 1.0 | 0.5 | 2.1% | 42.0% | 0 | 14 | 14 |

[symbol]

indicates data missing or illegible when filed

### <Properties of Multilayer Ceramic Capacitors According to the Specification of Ceramic Element and External Electrode>

As shown in Table 3, the length (L) and the width (W) of one surface of the ceramic element 10 were set to 1.0 mm and 0.5 mm respectively, and the area (A) of the first or second external electrode 31 or 32 was variously changed. Then, among the plurality of chips, the number of chips in which the first or second lead part 23 or 24 was electrically disconnected from the first or second external electrode 31 or 32, or delamination occurred was checked, and adhesive strength values of the chips were checked.

Referring to Table 3, in Samples 1 and 2, which were Comparative Examples, the ratio of an area of the first or second external electrode 31 or 32 to an area of one surface of the ceramic element 10 was below 10%. In these cases, many defective products having disconnection between the first or second external electrode 31 or 32 and the lead part 23 or 24 due to low adhesive strength were found, and thus, it could be seen that there were defects in reliability thereof.

In addition, in Samples 9 and 10, which were Comparative Examples, the ratio of an area of the first or second external electrode 31 or 32 to an area of one surface of the ceramic element 10 was above 40%. In these cases, there were no defects in relation to connection between the external electrode and the lead part, but many defective products having delamination due to a reduction in an area of the margin part of the ceramic element 10 were found, and thus, it could be seen that there were defects in reliability thereof.

Therefore, according to Tables 1 through 3, when the ratio of an area of the first or second external electrode 31 or 32 to an area of one surface of the ceramic element 10 is 10 to 40%, the adhesive strength is maintained, thereby stably maintaining connectivity between the external electrode and the lead part, and the margin part of the ceramic element 10 is sufficiently secured, thereby preventing delamination. In other words, it can be seen that the ratio of an area of the first or second external electrode 32 or 32 to an area of one surface of the ceramic element 10 is preferably within a numerical range of 10 to 40%.

In addition, according to Tables 1 through 3, when the ratio of the distance (a) between the first or second external electrode 31 or 32 and the end of the ceramic element 10 to the length (L) of one surface of the ceramic element 10 is maintained to be 4 to 18%, the margin part of the ceramic element 10 is sufficiently secured, thereby preventing delamination, and the exposed area of the electrode is sufficiently secured, thereby stably maintaining connectivity between the first or second external electrode 31 or 32 and the first or the second lead part 23 or 24. In other words, it can be seen that the ratio of the distance (a) between the first or second external electrode 31 or 32 and the end of the ceramic element 10 to the length (L) of one surface of the ceramic element 10 is preferably within a numerical range of 4 to 18%.

Hereinafter, a method of manufacturing a multilayer ceramic capacitor according to the embodiment of the present invention will be described.

A plurality of ceramic green sheets are prepared.

The ceramic green sheets are to form the dielectric layers of the ceramic element 10, and may be formed by mixing ceramic powder, a polymer, and a solvent to prepare a slurry and then molding the slurry into sheets having a thickness of several μm through doctor blade method or the like.

Then, first and second internal electrode layers each are formed by printing a conductive paste on at least one surface of each of the ceramic green sheets in a predetermined thickness, for example, 0.2 to 1.0 μm.

Here, the conductive paste may be printed such that margin parts having a predetermined width between edges of each ceramic green sheet and the first and second internal electrode layers are formed.

Then, first and second lead layers each are formed by printing a conductive paste on the margin part of each ceramic green sheet in the forward direction so as to have a predetermined thickness, for example, 0.2 to 1.0 μm, in a similar manner in which the first and second internal electrode layers are formed. Here, the first and second lead layers are formed such that first and second internal lead layers are connected to surfaces of first and second ceramic green sheets in the forward direction.

Since the first and second internal electrode layers have different polarities, the first and second lead layers are disposed alternately with each other such that they do not overlap in the length direction the first and second internal electrode layers when the plurality of green sheets are laminated.

In addition, preferably, the first and second lead layers may have the same width, but the present invention is not limited thereto. The widths of the first and second lead layers may be different, as necessary.

As a printing method of the conductive paste, screen printing, gravure printing, or the like may be employed. Examples of the conductive paste may include metal powder, ceramic powder, silica (SiO₂) powder, or the like.

The conductive paste may have an average particle size of 50 to 400 nm, but the present invention is not limited thereto.

Also, the metal powder may be one of nickel (Ni), manganese (Mn), chromium (Cr), cobalt (Co), and aluminum (Al), or an alloy thereof.

Thereafter, the plurality of ceramic green sheets having the first and second internal electrode layers and the first and second lead layers formed thereon are laminated and pressurized in a lamination direction, such that the plurality of ceramic green sheets laminated and the conductive paste formed on each of the ceramic green sheets are compressed to each other.

Therefore, a laminate in which the plurality of dielectric layers and the plurality of first and second internal electrodes 21 and 22 are alternately laminated, and the first lead part 23 and the second lead part 24 are alternately disposed in length direction of the first and second internal electrode 21 or 22, may be formed.

Thereafter, the laminate is cut into units of a region corresponding to one capacitor and individualized into each chip, and then the chips are sintered at a high temperature, thereby completing the ceramic element 10.

Then, the first and second external electrodes 31 and 32 are formed to cover the ends of the first and second lead parts 23 and 24 exposed through one surface of the ceramic element 10 in the forward direction.

In other words, the first and second external electrodes 31 and 32 are connected to the first and second lead parts 23 and 24, respectively, so that they can be electrically connected to the first and second internal electrodes 21 and 22.

Here, a ratio of an area of the first or second external electrode 31 or 32 to an area of one surface of the laminate may be set to 10 to 40%.

Here, a ratio of a distance between the first or second external electrode 31 or 32 and an end of the laminate to a length of one surface of the laminate may be set to 4 to 18%.

Also, as necessary, surfaces of the first and second external electrodes 31 and 32 may be plate-treated with nickel, tin, or the like.

As set forth above, according to the embodiments of the present invention, a multilayer ceramic electronic part, in which adhesive strength is increased and warpage cracks are prevented by controlling the size of an external electrode can be provided.

While the present invention has been shown and described in connection with the embodiments, it will be apparent to those in the art that modifications and variations can be made without departing from the spirit and scope of the invention as defined by the appended claims.

What is claimed is:

1. A multilayer ceramic electronic part, comprising:
a ceramic element having a plurality of dielectric layers laminated therein;
first and second internal electrodes formed on at least one surface of each of the plurality of dielectric layers within the ceramic element and exposed through one surface of the ceramic element; and
first and second external electrodes formed on one surface of the ceramic element and electrically connected to the first and second internal electrodes through exposed portions of the respective first and second internal electrodes,
wherein a ratio of an area of the first or second external electrode to an area of one surface of the ceramic element is 10 to 40%.

2. The multilayer ceramic electronic part of claim 1, wherein the first and second external electrodes have equal areas.

3. The multilayer ceramic electronic part of claim 1, wherein the first and second external electrodes have unequal areas.

4. The multilayer ceramic electronic part of claim 1, wherein a distance between the first external electrode and an end of the ceramic element is equal to a distance between the second external electrode and an opposite end of the ceramic element.

5. The multilayer ceramic electronic part of claim 1, wherein a distance between the first external electrode and an end of the ceramic element is different from a distance between the second external electrode and an opposite end of the ceramic element.

6. The multilayer ceramic electronic part of claim 1, wherein the first and second external electrodes are biased towards one side of the ceramic element in a length direction thereof.

7. The multilayer ceramic electronic part of claim 1, wherein the first and second external electrodes are left-and-right symmetrical with regard to a middle of the ceramic element.

8. The multilayer ceramic electronic part of claim 1, wherein the first and second external electrodes are formed such that all margin parts of the ceramic element have the same width.

9. A multilayer ceramic electronic part, comprising:
a ceramic element having a plurality of dielectric layers laminated therein;
first and second internal electrodes formed on at least one surface of each of the plurality of dielectric layers within the ceramic element and exposed through one surface of the ceramic element; and
first and second external electrodes formed on one surface of the ceramic element and electrically connected to the first and second internal electrodes through exposed portions of the respective first and second internal electrodes,
wherein a ratio of a distance between the first or second external electrode and an end of the ceramic element to a length of one surface of the ceramic element is 4 to 18%.

10. The multilayer ceramic electronic part of claim 9, wherein a distance between the first external electrode and an end of the ceramic element is equal to a distance between the second external electrode and an opposite end of the ceramic element.

11. The multilayer ceramic electronic part of claim 9, wherein a distance between the first external electrode and an end of the ceramic element is different from a distance between the second external electrode and an opposite end of the ceramic element.

12. The multilayer ceramic electronic part of claim 9, wherein the first and second external electrodes are biased towards one side of the ceramic element in a length direction thereof.

13. The multilayer ceramic electronic part of claim 9, wherein the first and second external electrodes are left-and-right symmetrical with regard to a middle of the ceramic element.

14. The multilayer ceramic electronic part of claim 9, wherein the first and second external electrodes are formed such that all margin parts of the ceramic element have the same width.

15. A method of manufacturing a multilayer ceramic electronic part, comprising:
forming first and second internal electrode layers on at least one surface of each of first and second ceramic sheets;
alternately laminating the first and second ceramic sheets having the respective first and second internal electrode layers formed thereon, to form a laminate;
sintering the laminate; and
forming first and second external electrodes on one surface of the laminate so as to be electrically connected to the respective first and second internal electrode layers,
wherein a ratio of an area of the first or second external electrode to an area of one surface of the laminate is 10 to 40%.

16. The method of claim 15, wherein the first external electrode and the second external electrode have equal areas.

17. The method of claim 15, wherein the first external electrode and the second external electrode have unequal areas.

18. The method of claim 15, wherein a distance between the first external electrode and an end of the laminate is equal to a distance between the second external electrode and an opposite end of the laminate.

19. The method of claim 15, wherein a distance between the first external electrode and an end of the laminate is different from a distance between the second external electrode and an opposite end of the laminate.

20. The method of claim 15, wherein the first and second external electrodes are biased towards one side of the laminate in a length direction thereof.

21. The method of claim 15, wherein the first and second external electrodes are left-and-right symmetrical with regard to a middle of the laminate.

22. The method of claim 15, wherein the first and second external electrodes are formed such that all margin parts of the laminate have the same width.

23. A method of manufacturing a multilayer ceramic electronic part, comprising:
forming first and second internal electrode layers on at least one surface of each of first and second ceramic sheets;
alternately laminating the first and second ceramic sheets having the respective first and second internal electrode layers formed thereon, to form a laminate;
sintering the laminate; and
forming first and second external electrodes on one surface of the laminate so as to be electrically connected to the respective first and second internal electrode layers,
wherein a ratio of a distance between the first or second external electrode and an end of the laminate to a length of one surface of the laminate is 4 to 18%.

24. The method of claim 23, wherein a distance between the first external electrode and an end of the laminate is equal to a distance between the second external electrode and an opposite end of the laminate.

25. The method of claim 23, wherein a distance between the first external electrode and an end of the laminate is different from a distance between the second external electrode and an opposite end of the laminate.

26. The method of claim 23, wherein the first and second external electrodes are biased towards one side of the laminate in a length direction thereof.

27. The method of claim 23, wherein the first and second external electrodes are left-and-right symmetrical with regard to a middle of the laminate.

28. The method of claim 23, wherein the first and second external electrodes are formed such that all margin parts of the laminate have the same width.
